(19) United States
(12) Patent Application Publication
(10) Pub. No.: US 2024/0340764 A1
(43) Pub. Date: Oct. 10, 2024

(54) RLF AND RECOVERY ASSOCIATED WITH MULTIHOP AND MULTICONNECTIVITY RELAYS

(71) Applicant: InterDigital Patent Holdings, Inc., Wilmington, DE (US)

(72) Inventors: Martino M. Freda, Laval (CA); Oumer Teyeb, Montreal (CA); Tuong Duc Hoang, Montreal (CA); Jaya Rao, Montreal (CA); Moon-il Lee, Melville, NY (US)

(73) Assignee: InterDigital Patent Holdings, Inc., Wilmington, DE (US)

(21) Appl. No.: 18/681,345

(22) PCT Filed: Jul. 29, 2022
(86) PCT No.: PCT/US2022/038766

§ 371 Date: Feb. 5, 2024

Related U.S. Application Data
(60) Provisional application No. 63/228,874, filed on Aug. 3, 2021.

(51) Int. Cl. H04W 40/22; H04W 36/00; H04W 76/18

(52) U.S. Cl. CPC H04W 40/22; H04W 36/0079; H04W 76/18

(57) ABSTRACT

Systems, methods, and instrumentalities are described herein related to radio-link failure (RLF) and recovery for multihop and multiconnectivity relays. A wireless transmit/receive unit (WTRU) may act as a relay to another WTRU (e.g., a remote WTRU). For example, a first WTRU may act as a relay WTRU (e.g., a WTRU to network relay) towards a second WTRU (e.g., a remote WTRU). The first WTRU may provide information associated with cell reselection and/or re-establishment to the second WTRU (e.g., if the first WTRU experiences a radio-link failure).

### CROSS-REFERENCE TO RELATED APPLICATIONS

This application claims the benefit of Provisional U.S. Patent Application No. 63/228,874, filed Aug. 3, 2021, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to radio-link failure (RLF) and recovery for multihop and multiconnectivity relays. A wireless transmit/receive unit (WTRU) may act as a relay to another WTRU (e.g., a remote WTRU). For example, a first WTRU may act as a relay WTRU (e.g., a WTRU to network relay) towards a second WTRU (e.g., a remote WTRU). The first WTRU may provide information associated with cell reselection and/or re-establishment to the second WTRU (e.g., if the first WTRU experiences a radio-link failure).

In examples, a relay WTRU associated with a remote WTRU may receive an indication of a threshold and a logical channel weight. The relay WTRU may determine a number of hops from the relay WTRU to a network. The relay WTRU may send an indication of a radio link failure (RLF) to the remote WTRU. For example, the indication of the RLF may be a first type RLF indication or a second type RLF indication. If the relay WTRU is associated with a first operating condition and the relay WTRU did not receive the second type RLF indication from a parent relay, the relay WTRU may determine a value associated with the logical channel weight and the number of hops. If the value is less than the threshold, the indication of the RLF may be a first type RLF indication. If the value is greater than the threshold, the indication of the RLF may be the second type RLF indication. If the relay WTRU is associated with a second operating condition or if the relay WTRU receives a second type RLF indication from a parent relay, the indication of the RLF may be the second type RLF indication.

In examples, actions may be based on sidelink (SL) and/or user-to-user (Uu) RLF at a relay WTRU. A WTRU may send and/or forward a request to be informed of SL RLF and/or recovery. A WTRU may receive a set of remote WTRUs, for example, to forward the RLF indication and/or recover from a network. A WTRU may determine its actions if receiving an RLF indication from a parent WTRU. In examples, successful (re) selection of a cell and/or and re-establishment may be informed to a remote WTRU. Whether to perform cell and/or relay (re) selection may be conditioned on one or more aspects at the relay or the relay's child WTRU(s). Whether to select a relay may be conditioned on a whether the relay is in radio resource control connected (RRC_CONNECTED). A relay WTRU indication of RLF to a remote WTRU may depend on the types of RLF (e.g., master RLF (M-RLF) or secondary RLF (S-RLF)). A relay WTRU and/or remote WTRU may suspend SL transmission and/or reception based on RLF indication transmission and/or reception. Remote WTRU(s) may have different behavior based on reception of different RLF types from the relay WTRU. A remote WTRU may determine which Uu bearer(s) to suspend transmission on based on the RLF indication. A remote WTRU may activate, deactivate, or switch a packet data convergence protocol (PDCP) entity based on reception of an RLF indication.

In examples, a relay WTRU may receive an indication of a request, from a first WTRU, to relay an RLF indication. The relay WTRU may determine a relay request based on a radio resource control (RRC) state. The relay WTRU may send an indication of the relay request to a second WTRU. In examples, the relay WTRU may determine a distance value based on one or more relay characteristics. On a condition that the RLF indication is received from the second WTRU, the relay WTRU may send the RLF indication to the first WTRU, where a first RLF indication type is sent if the distance value is less than a threshold and a second RLF indication is sent if the distance value is greater than or equal to a threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example user plane radio protocol stack for layer 2 evolved WTRU-to-network relay (e.g., PC5).

FIG. 3 shows an example control plane radio protocol stack for layer 2 evolved WTRU-to-network relay (e.g., PC5).

FIG. 4 shows an example radio link failure (RLF) and recovery in multihop and/or multiconnectivity WTRU-to-network (NW) Relays.

FIG. 5 shows an example architecture where the relay WTRU is configured in dual connectivity (DC) with a master cell group (MCG) and a secondary cell group (SCG).

FIG. 6 shows an example architecture where the relay WTRU is configured with an MCG and a SCG.

### DETAILED DESCRIPTION

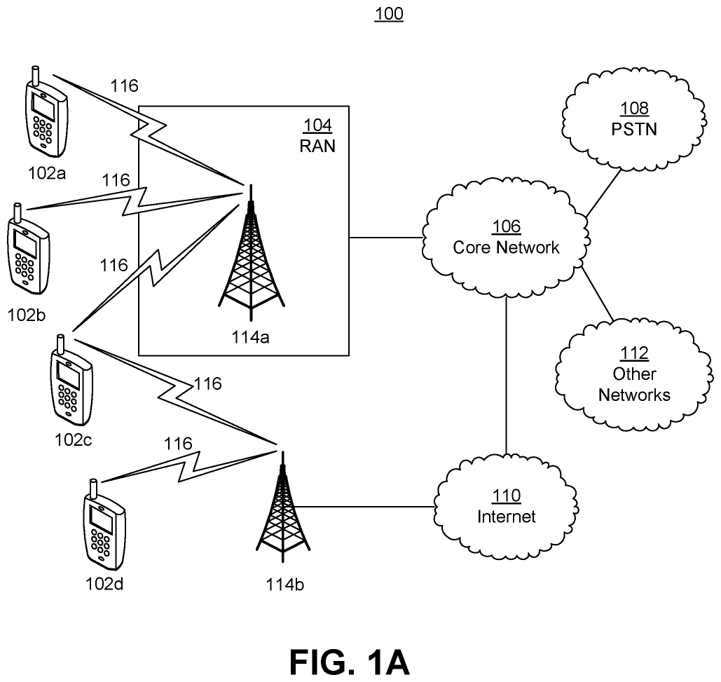

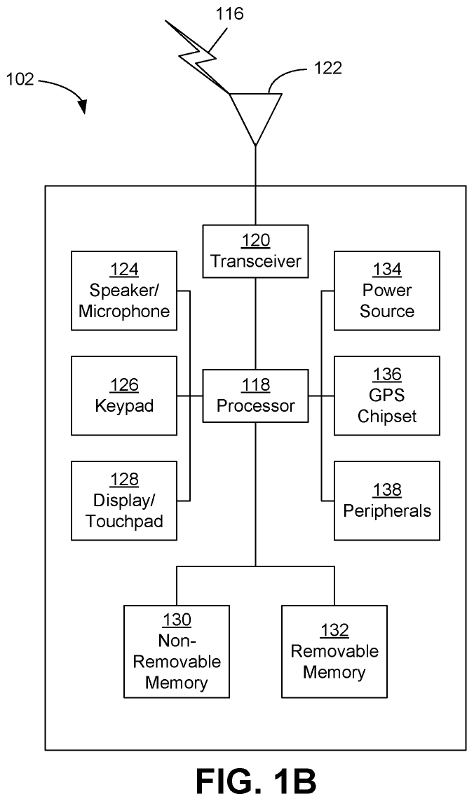

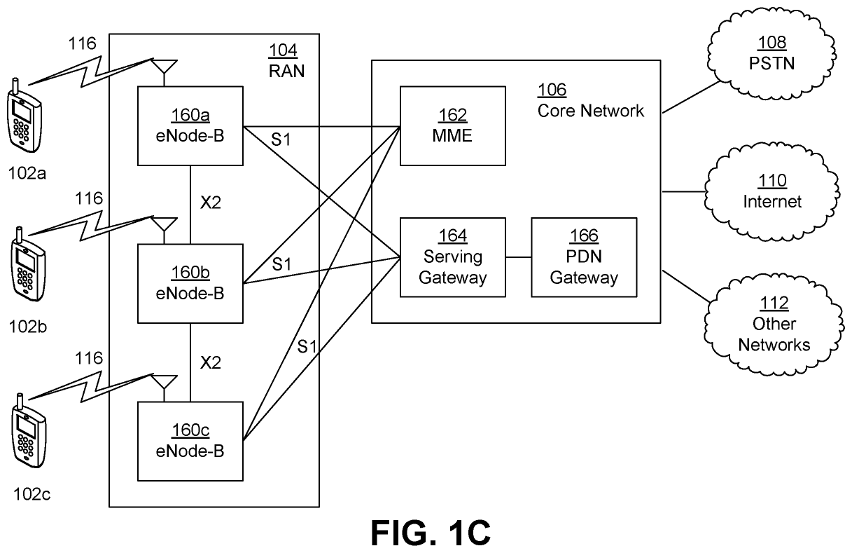

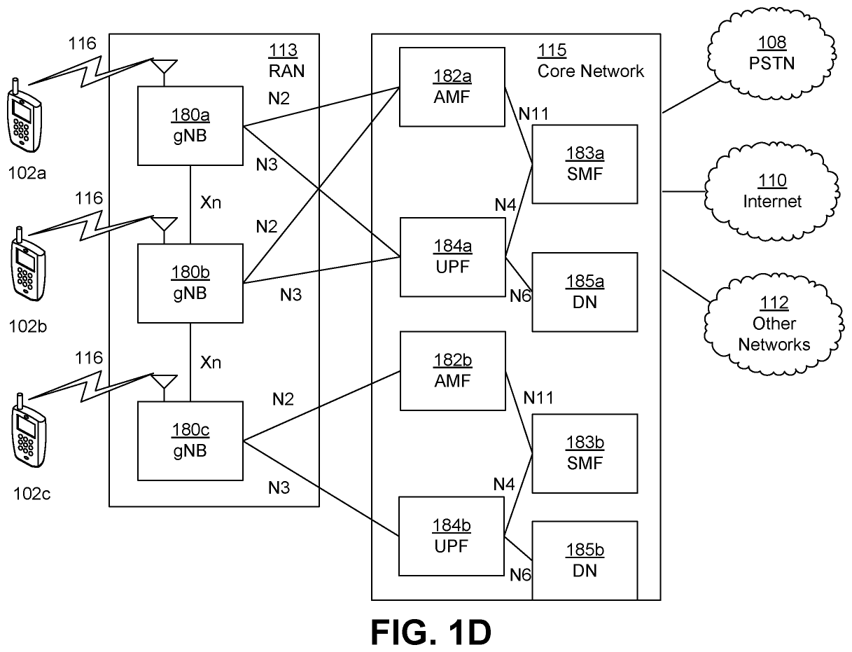

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, tracking the time, tracking the period of time, etc. Reference to a timer expiration herein may refer to determining that the time has occurred or that the period of time has expired.

Systems, methods, and instrumentalities are described herein related to radio-link failure (RLF) and recovery for multihop and multiconnectivity relays. A wireless transmit/receive unit (WTRU) may act as a relay to another WTRU (e.g., a remote WTRU). For example, a first WTRU may act as a relay WTRU (e.g., a WTRU to network relay) towards a second WTRU (e.g., a remote WTRU). The first WTRU may provide information associated with cell reselection and/or re-establishment to the second WTRU (e.g., if the first WTRU experiences a radio-link failure).

In examples, a relay WTRU associated with a remote WTRU may receive an indication of a threshold and a logical channel weight. The relay WTRU may determine a number of hops from the relay WTRU to a network. The relay WTRU may send an indication of a radio link failure (RLF) to the remote WTRU. For example, the indication of the RLF may be a first type RLF indication or a second type RLF indication. If the relay WTRU is associated with a first operating condition and the relay WTRU did not receive the second type RLF indication from a parent relay, the relay WTRU may determine a value associated with the logical channel weight and the number of hops. If the value is less than the threshold, the indication of the RLF may be a first type RLF indication. If the value is greater than the threshold, the indication of the RLF may be the second type RLF indication. If the relay WTRU is associated with a second operating condition or if the relay WTRU receives a second type RLF indication from a parent relay, the indication of the RLF may be the second type RLF indication.

In examples, actions may be based on sidelink (SL) and/or user-to-user (Uu) RLF at a relay WTRU. A WTRU may send and/or forward a request to be informed of SL RLF and/or recovery. A WTRU may receive a set of remote WTRUs, for example, to forward the RLF indication and/or recover from a network. A WTRU may determine its actions if receiving an RLF indication from a parent WTRU. In examples, successful (re) selection of a cell and/or and re-establishment may be informed to a remote WTRU. Whether to perform cell and/or relay (re) selection may be conditioned on one or more aspects at the relay or the relay's child WTRU(s). Whether to select a relay may be conditioned on a whether the relay is in radio resource control connected (RRC_CONNECTED). A relay WTRU indication of RLF to a remote WTRU may depend on the types of RLF (e.g., master RLF (M-RLF) or secondary RLF (S-RLF)). A relay WTRU and/or remote WTRU may suspend SL transmission and/or reception based on RLF indication transmission and/or reception. Remote WTRU(s) may have different behavior based on reception of different RLF types from the relay WTRU. A remote WTRU may determine which Uu bearer(s) to suspend transmission on based on the RLF indication. A remote WTRU may activate, deactivate, or switch a packet data convergence protocol (PDCP) entity based on reception of an RLF indication.

In examples, a relay WTRU may receive an indication of a request, from a first WTRU, to relay an RLF indication. The relay WTRU may determine a relay request based on a radio resource control (RRC) state. The relay WTRU may send an indication of the relay request to a second WTRU. In examples, the relay WTRU may determine a distance value based on one or more relay characteristics. On a condition that the RLF indication is received from the second WTRU, the relay WTRU may send the RLF indication to the first WTRU, where a first RLF indication type is sent if the distance value is less than a threshold and a second RLF indication is sent if the distance value is greater than or equal to a threshold.

A relay WTRU (e.g., where the relay WTRU may be an SL relay WTRU, which may be used as an example relay WTRU) may determine whether and/or how to send an indication to a child node (e.g., a child relay or a remote WTRU) of a radio link failure (RLF) based on one or more of the following: a request from the child node; a hop count associated with the relay WTRU (e.g., a number of hops from the relay WTRU or remote WTRU to a network device, such as a gNB, base station, etc.); or a QoS of the relayed data (e.g., a priority/weight of a channel, for example a logical channel, such as an RLC channel).

An SL relay WTRU may do one or more of the following (e.g., associated with informing a child node of an RLF). The SL WTRU may receive a request (e.g., from one or more remote WTRUs) to relay an RLF indication. The SL WTRU may determine to send its own request (e.g., to a parent relay WTRU) to receive an RLF indication (e.g., from the parent relay WTRU), where the determination may be based on one or more of the following: a reception of a request to relay an RLF failure indication from one or more remote WTRU(s); or whether the SL relay WTRU is in an operating condition (e.g., such as an RRC_CONNECTED condition). The SL WTRU may send the request to a parent relay WTRU. The SL WTRU may determine a distance metric based on one or more of the following: a hop count to the network (e.g., gNB, base station, etc.), for example a hop count from the SL WTRU to the network; the QoS of the data being relayed (e.g., a priority/weight of a channel, for example a logical channel, such as an RLC channel); or an operating condition of the SL WTRU (e.g., an RRC operating condition, such as CONNECTED, IDLE, etc.). The SL WTRU may forward the distance metric to the child WTRU. If an RLF indication is received from the parent relay WTRU and/or RLF is triggered at the SL relay WTRU, the SL relay WTRU may do one or more of the following: send an RLF indication to remote WTRU(s) (e.g., all remote WTRUs) that requested the indication, where a first type RLF indication is sent if the relay WTRU has a distance metric that is below a threshold and a second type RLF indication is sent otherwise; initiate relay and/or cell reselection and/or re-establishment depending on the operating condition (e.g., RRC operating condition) of the relay WTRU; or, in the case where a first RLF indication was sent and re-establishment is successful, send an indication to the remote WTRU(s) that requested an RLF indication that re-establishment is successful.

An SL remote WTRU may determine whether and/or when to trigger re-establishment following reception of an RLF indication from a relay, e.g., based on the type of RLF indication.

An SL remote WTRU may transmit, to a relay WTRU, a request to receive an RLF indication, for example, if the SL remote WTRU is moving to or has moved to RRC_CONNECTED. An SL remote WTRU may, on condition of reception of a first RLF indication type from the relay WTRU, initiate and/or track a recovery time (e.g., via a recovery timer) and/or trigger cell and/or relay re-selection and/or re-establishment on condition of expiry of the recovery time (e.g., recovery timer) and/or reception of a recovery failure from the relay WTRU. An SL remote WTRU may, on condition of reception of a second RLF indication type, perform cell and/or relay re-selection and/or re-establishment based on reception (e.g., immediately based on reception) of the indication.

NR sidelink may support vehicle to anything (V2X)-related road safety services. Broadcast, groupcast, and/or unicast communications may be supported in out-of-coverage and in-network coverage scenarios. Sidelink-based relaying functionality may provide sidelink and/or network coverage extension and/or power efficiency improvement, considering wider range of applications and services.

Coverage extension for sidelink-based communication may include WTRU-to-network coverage extension and/or WTRU-to-WTRU coverage extension. For WTRU-to-network coverage extension, WTRU coverage reachability may be used for WTRUs to reach server(s) in a packet data network (PDN) and/or counterpart WTRUs out-of-proximity area. Techniques for WTRU-to-network relay limited to evolved universal terrestrial radio access (EUTRA)-based technology may not be able to be applied to NR-based system for NG-RAN and NR-based sidelink communication. In examples, for WTRU-to-WTRU coverage extension, proximity reachability may be limited to single-hop sidelink link via EUTRA-based or NR-based sidelink technology, which may cause issues in the scenario where there is no Uu coverage, e.g., considering the limited single-hop sidelink coverage.

Sidelink connectivity may be extended in an NR framework, e.g., in order to support the enhanced QoS requirements.

In examples, WTRU-to-network relays may be provided. Relaying via ProSe WTRU-to-network relays may extend network coverage to an out-of-coverage WTRU by using PC5 (e.g., D2D) between an out of coverage WTRU and a WTRU-to-network relay.

A ProSe WTRU-to-network relay may provide a generic layer 3 (L3) forwarding function, for example, that may relay a type of IP traffic (e.g., any type of IP traffic) between the remote WTRU and the network. One-to-one and one-to-multiple sidelink communications may be used between the remote WTRU(s) and the ProSe WTRU-to-network relay. For remote WTRU and relay WTRU, one carrier (e.g., public safety ProSe carrier) operation may be supported (e.g., Uu and PC5 may be the same carrier for relay and remote WTRU). The remote WTRU may be authorized by upper layers and may be in-coverage of the public safety ProSe carrier or out-of-coverage on any supported carriers including public safety ProSe carrier for WTRU-to-network relay discovery, (re) selection, and/or communication. The ProSe WTRU-to-network relay may be (e.g., may be always) in-coverage of EUTRAN. The ProSe WTRU-to-network relay and the remote WTRU may perform sidelink communication and/or sidelink discovery, respectively.

Relay selection or reselection for ProSe WTRU to NW relays may be performed, for example, based on a combination of an AS layer quality measurements (e.g., reference signal received power (RSRP)) and upper layer criteria.

The eNB may control whether the WTRU acts as a ProSe WTRU-to-network relay. ProSe WTRU-to-network relay operation may be supported in the cell, for example, if the eNB broadcasts information (e.g., any information) associated with ProSe WTRU-to-network relay operation. The eNB may provide transmission resources for ProSe WTRU-to-network relay discovery, for example, using broadcast signaling for RRC_IDLE state and/or dedicated signaling for RRC_CONNECTED state. The eNB may provide reception resources for ProSe WTRU-to-network relay discovery, for example, using broadcast signaling. The eNB may broadcast a minimum and/or a maximum WTRU link quality (e.g., RSRP) threshold(s) that the ProSe WTRU-to-network relay may respect before it initiates a WTRU-to-network relay discovery. In RRC_IDLE, the WTRU may use the threshold(s) to autonomously start or stop the WTRU-to-network relay discovery if the eNB broadcasts the transmission resource pools. In RRC_CONNECTED, the WTRU may use the threshold(s) to determine if it may indicate to eNB that it is a relay WTRU and wants to start ProSe WTRU-to-network relay discovery. A WTRU may initiate a request for ProSe-WTRU-to-network relay discovery resources by dedicated signalling (e.g., respecting the broadcasted threshold(s)) if the eNB does not broadcast transmission resource pools for ProSe WTRU-to-network relay discovery. The ProSe-WTRU-to-network relay may perform ProSe WTRU-to-network relay discovery (e.g., when in RRC_IDLE) if the ProSe-WTRU-to-network relay is initiated by broadcast signaling. The ProSe-WTRU-to-network relay may perform relay discovery (e.g., as long as it is in RRC_CONNECTED) if the ProSe WTRU-to-network relay is initiated by dedicated signaling.

A ProSe WTRU-to-network relay performing sidelink communication for ProSe WTRU-to-network relay operation may be in RRC_CONNECTED. The ProSe WTRU-to-network relay may indicate to the eNB that it is a ProSe WTRU-to-network relay and it intends to perform ProSe WTRU-to-network relay sidelink communication, for example, if the ProSe receives a layer-2 link establishment request and/or a temporary mobile group identity (TMGI) monitoring request (e.g., upper layer message) from a remote WTRU. In examples, the eNB may provide resources for ProSe WTRU-to-network relay communication.

The remote WTRU may decide to start monitoring for ProSe WTRU-to-network relay discovery. The remote WTRU may transmit ProSe WTRU-to-network relay discovery solicitation messages if in RRC_IDLE or in RRC_CONNECTED depending on the configuration of resources for ProSe WTRU-to-network relay discovery. The eNB may broadcast a threshold, which may be used by the remote WTRU to determine if the eNB may transmit ProSe WTRU-to-network relay discovery solicitation messages to connect and/or communicate with a ProSe WTRU-to-network relay WTRU. The RRC_CONNECTED remote WTRU may use the broadcasted threshold to determine if it may indicate to eNB that it is a remote WTRU and it wants to participate in ProSe WTRU-to-network relay discovery and/or communication. The eNB may provide transmission resources using broadcast and/or dedicated signaling and/or may provide reception resources using broadcast signaling for ProSe WTRU-to-network relay operation. The remote WTRU may stop using ProSe WTRU-to-network relay discovery and/or communication resources, for example, if the RSRP goes above the broadcasted threshold. Time of traffic switching from Uu to PC5 or vice versa may be determined by a higher layer.

The remote WTRU may perform radio measurements at a PC5 interface and may use the radio measurements for ProSe WTRU-to-network relay selection or reselection along with higher layer criteria. A ProSe WTRU-to-network relay may be considered suitable in terms of radio criteria, for example, if the PC5 link quality exceeds a configured threshold (e.g., pre-configured or provided by eNB). The remote WTRU may select the ProSe WTRU-to-network relay, which may satisfy higher layer criteria and may have the best PC5 link quality among suitable ProSe WTRU-to-network relays (e.g., all suitable ProSe WTRU-to-network relays).

The remote WTRU may trigger ProSe WTRU-to-network relay reselection, for example, if a PC5 signal strength of a current ProSe WTRU-to-network relay is below a configured signal strength threshold and/or if the remote WTRU receives a layer-2 link release message (e.g., upper layer message) from ProSe WTRU-to-network relay.

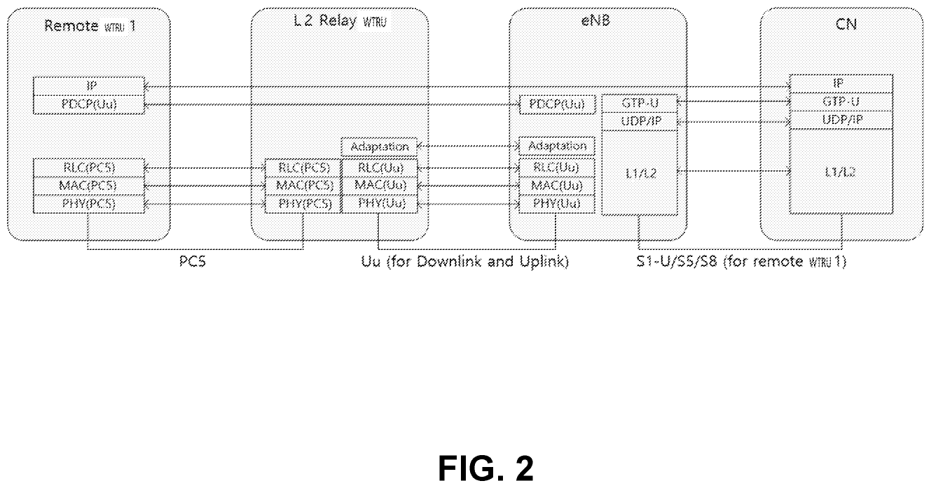

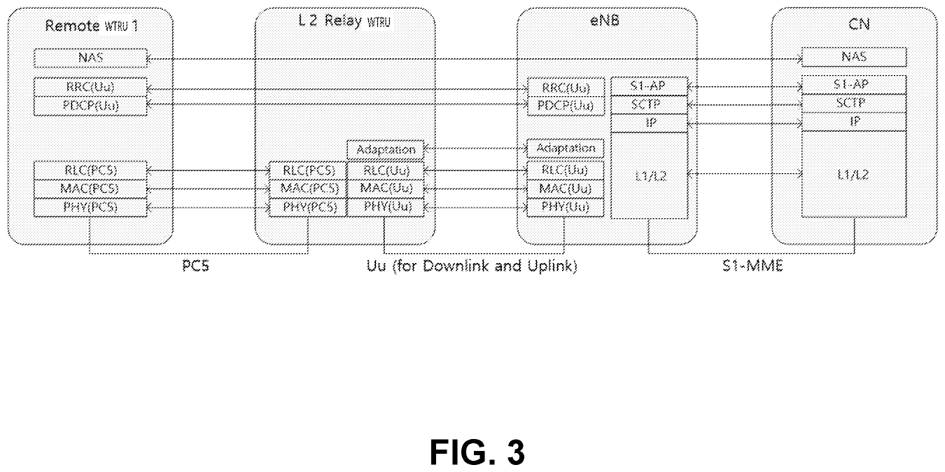

WTRU-to-network (NW) relays may be used for wearable devices. ProSe WTRU-to-NW relays may use an L3 (e.g., IP layer) relaying approach. The WTRU-to-NW relays for wearables may be expected to be an L2 relay, e.g., based on the protocol stacks shown in FIG. 2. FIG. 2 shows an example user plane radio protocol stack for layer 2 evolved WTRU-to-network relay (e.g., PC5). FIG. 3 shows an example control plane radio protocol stack for layer 2 evolved WTRU-to-network relay (e.g., PC5).

Connection establishment for unicast link in NR V2X may be provided. Relay techniques may be based on a one-to-one communication link established at upper layers (e.g., ProSe layer) between WTRUs (e.g., two WTRUs such as the remote WTRU and WTRU-to-NW relay). Such a connection may be transparent to the AS layer and connection management signaling and procedures performed at the upper layers may be carried out by AS layer data channels. In examples, the AS layer may be unaware of the one-to-one connection.

In NR V2X, the AS layer may support a unicast link between WTRUs (e.g., two WTRUs). The unicast link may be initiated by upper layers (e.g., as in the ProSe one-to-one connection). The AS layer may be informed of the presence of the unicast link and data (e.g., any data) that is transmitted in unicast fashion between the peer WTRUs. With such knowledge, the AS layer may support HARQ feedback, channel quality indicator (CQI) feedback, and/or power control schemes which may be associated with unicast.

A unicast link at the AS layer may be supported via a PC5-RRC connection. The PC5-RRC connection may be defined as follows. The PC5-RRC connection may be a logical connection between a pair of a source layer-2 ID and a destination layer-2 ID in the AS. One PC5-RRC connection may correspond to one PC5 unicast link. The PC5-RRC signaling may be initiated based on its corresponding PC5 unicast link establishment. The PC5-RRC connection and the corresponding sidelink SRBs and/or sidelink DRBs may be released when the PC5 unicast link is released, for example, as indicated by upper layers.

For a PC5-RRC connection of unicast (e.g., each PC5-RRC connection of unicast), one sidelink signal radio bearer (SRB) may be used to transmit the PC5-S messages (e.g., before the PC5-S security has been established). One sidelink SRB may be used to transmit the PC5-S messages to establish the PC5-S security. One sidelink SRB may be used to transmit the PC5-S messages, for example, after the PC5-S security has been established, which is protected. One sidelink SRB may be used to transmit the PC5-RRC signaling, which may be protected and sent (e.g., only sent) after the PC5-S security has been established.

PC5-RRC signaling may include a sidelink configuration message (e.g., RRCReconfigurationSidelink) where a WTRU may configure the Rx-related parameters of a sidelink radio bearer (SLRB) (e.g., each SLRB) in the peer WTRU. In examples, the reconfiguration message may configure the parameter(s) of a protocol (e.g., each protocol) in the L2 stack (e.g., service data adaptation protocol (SDAP), packet data convergence protocol (PDCP), etc.). The receiving WTRU may confirm or reject the configuration, for example, depending on whether it may support the configuration suggested by the peer WTRU.

RLF may be used for single hop WTRU-to-NW relays. The following may be relevant to RLF for SL relays and integrated access and backhaul (IAB).

In examples, if Uu RLF is detected by a relay WTRU, the relay WTRU may send a PC5-S message to its connected remote WTRU(s) and this message may trigger relay reselection. In examples, the Uu RLF indication from the relay WTRU may trigger the remote WTRU connection re-establishment. In examples, the Uu RLF indication from the relay WTRU may trigger the remote WTRU connection re-establishment. In examples, the remote WTRU may trigger the remote WTRU connection re-establishment based on detecting PC5 RLF.

In examples, one or more of the following may apply to IAB. The trigger to generate a type 2 RLF indication may be (e.g., occur) at RLF detection. The trigger for type 3 RLF indication transmission may be (e.g., indicate) successful recovery after BH RLF. Type 2 and type 3 BH RLF indication may be transmitted via backhaul adaptation layer (BAP) control PDU. Based on reception of the type-2 indication, the IAB node may not initiate RRC re-establishment.

In single hop, single connectivity, and WTRU-to-NW relay, a remote WTRU (e.g., in RRC_CONNECTED) may perform a recovery, for example, based on failure of a Uu connection. The recovery may be achieved by having the relay WTRU indicate the failure to the remote WTRU and having the remote WTRU trigger re-selection (e.g., cell and/or relay) and re-establishment (e.g., similar to WTRU). A similar mechanism may be present in IAB (e.g., BH RLF indication).

A reasonable instant of time for the relay WTRU to send the indication to the remote WTRU(s) may be based on a re-establishment failure. The relay WTRU may attempt recovery first before the remote WTRU attempts a similar procedure (e.g., by reselecting to a new relay).

In multihop, the technique described herein may not be used. To let a relay WTRU (e.g., each relay WTRU) to attempt its own re-establishment before indicating failure to the subsequent relay may result in delay at the relay node. In examples, some of the relay WTRUs along the chain may not be in RRC_CONNECTED and having them perform access to the network (e.g., to update the network with new connectivity information) may not be preferable. In examples, the amount of time (e.g., acceptable amount of time) the remote WTRU waits may differ depending on the QoS supported at the remote WTRU. A different approach may be possible as to which relay WTRU (e.g., along a chain) may be tasked with attempting a re-establishment and when to initiate a re-establishment (e.g., immediately based on an RLF or wait for the parent to attempt recovery).

When to perform re-establishment (e.g., at a remote WTRU or a relay WTRU in a multihop architecture) when an RLF is indicated by a parent relay WTRU may be determined.

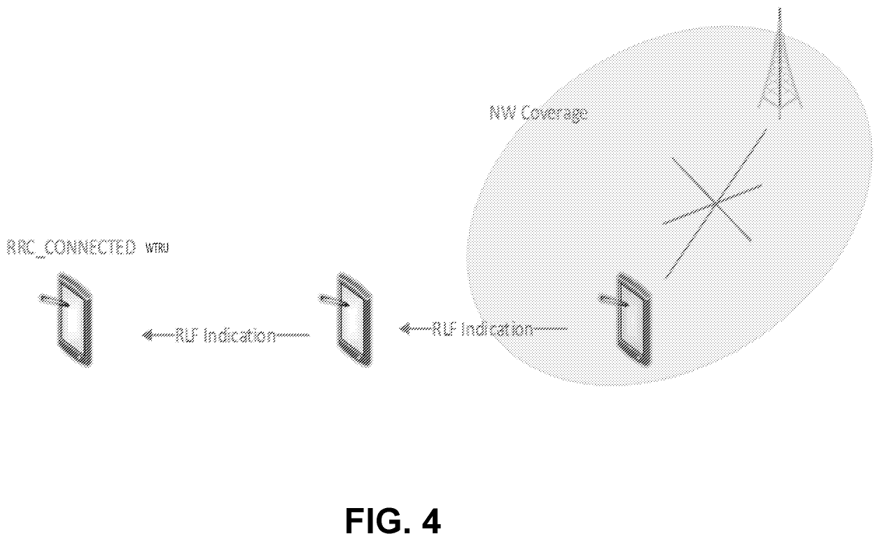

FIG. 4 shows an example RLF and recovery in multihop and/or multiconnectivity WTRU-to-NW relays. In examples, the RLF may be propagated to the connected WTRUs (e.g., all the connected WTRUs) in the multihop relaying. A multihop relay may serve as a relay WTRU to multiple remote WTRUs. The remote WTRUs may be relay WTRUs for their own remote WTRUs (e.g., in a multihop architecture). Remote WTRU, as described herein, may refer to the attached WTRUs in the downlink direction (e.g., for WTRU-to-network relays) and may include attached remote WTRUs which may be relay WTRUs. Relay WTRU, as described herein, may refer to the attached WTRUs in the uplink direction (e.g., for WTRU-to-network relays) which may serve as relays (e.g., WTRU-to-network) for the remote WTRU.

The techniques described herein may apply to different relaying scenarios. In examples, a relay WTRU may be an SL WTRU-to-NW relay, an SL WTRU-to-WTRU relay, or an IAB node.

Single connectivity may be provided. One or more actions may be included, for example, based on an SL/UU RLF at a relay WTRU.

A relay WTRU may perform one or more of the following actions based on detection of Uu RLF, detection of (e.g., SL) RLF, detection of beam failure (e.g., with respect to Uu, or SL via remote and/or relay WTRUs), and/or based on reception of an RLF indication from a parent relay WTRU. The actions may include one or more of the following: the relay WTRU may trigger Uu re-establishment; trigger relay reselection; cancel a previously initiated procedure (e.g., re-establishment, reselection, and/or access procedure); initiate an access procedure with the network; send an indication to upper layers and/or release the PC5-S connection; transmit a PC5-S message (e.g., at the upper layers via upper layer signaling), for example as opposed to transmission of an RLF indication (e.g., as described herein); send an indication to the remote WTRU of a successful or failed recovery procedure, for example if the procedure has completed (e.g., re-establishment or re-selection procedure is completed); or send an indication to the remote WTRU of the cell to which recovery has been performed or whether recovery was performed to the same cell or cell group. Initiating an access procedure with the network may comprise a connection establishment, a resume procedure, an RNA procedure, an RACH procedure, a small data transmission, and/or beam failure indication. A relay WTRU may send an indication to one or more of its connected remote WTRUs and/or child relay WTRUs, which may comprise one or more of the following: a relay WTRU may relay a received RLF indication (e.g., received from its own relay WTRU) to one or more remote WTRU (e.g., one or more of its next hop remote WTRUs); a relay WTRU may generate an RLF indication message (e.g., new RLF indication message) and transmit the message to one or more of the relay WTRU's remote WTRUs and/or child relay WTRUs. A relay WTRU may generate a different type of RLF indication message and/or an RLF indication message including different information (e.g., depending on one or more conditions described herein, such as, but not limited to a type of RLF indication received from a parent WTRU, an operating condition (e.g., RRC condition) of the relay WTRU, a logical channel priority (e.g., weight), a number of hops from the relay WTRU to the network (e.g., gNB, base station, etc.), a value associated with the logical channel priority and number of hops, or a threshold associated with the value).

The action(s), the order of the actions, and/or the type and/or information provided in messaging (e.g., any messaging such as RLF indication message, type of message, etc.) may depend on whether the relay WTRU is serving (e.g., serving only) as a relay to another remote WTRU or whether the relay WTRU is a WTRU with its own Uu traffic (e.g., the relay WTRU is a remote WTRU). This may be determined by the presence, at the relay WTRU, of its own DRBs (e.g., whether the relay WTRU has Uu traffic), which may be conditioned on the presence of a PDCP entity and/or an SDAP entity at the relay WTRU, the presence of a DRB configuration at the relay WTRU, and/or the presence of an adaptation layer associated with remote WTRU transmissions. Whether the relay WTRU has its own UU traffic may be determined by whether the relay WTRU has an RRC state with the network (e.g., RRC_IDLE, RRC_INACTIVE, or RRC_CONNECTED). For example, the relay WTRU, based on reception of an RLF indication and/or determination of SL RLF with a parent relay WTRU, may forward the RLF indication (e.g., or send an indication of the RLF) to the attached remote WTRU(s) and/or child relay WTRUs if the relay WTRU does not have established Uu DRBs (e.g., any established Uu DRBs). In examples, if the relay WTRU has its own established Uu DRBs, the relay WTRU may trigger a re-establishment procedure (e.g., if the relay WTRU is in RRC_CONNECTED) or a reselection procedure (e.g., if the relay WTRU is in RRC_INACTIVE or RRC_IDLE).

The action(s), the order of the actions, and/or the type and/or information provided in messaging (e.g., any messaging such as RLF indication message, type of message, etc.) may depend on the operating condition (e.g., RRC operating condition) of the relay WTRU, for example, if the relay WTRU is configured with an RRC state. A relay WTRU may trigger re-establishment if the relay WTRU is in RRC_CONNECTED. Otherwise (e.g., if the WTRU is not in RRC_CONECTED), a relay WTRU may relay a received RLF indication to its remote WTRU(s), or, send an RLF indication to its remote WTRU(s), e.g., if the relay WTRU triggers the RLF.

The action(s), the order of the actions, and/or the type and/or information provided in messaging (e.g., any messaging such as RLF indication message, type of message, etc.) may depend on the RRC state of attached remote WTRUs (e.g., any attached remote WTRUs in the downlink direction) and/or parent relay WTRUs (e.g., in the uplink direction), based on information that may be received from the WTRUs (e.g., as described herein). For example, if one or more of the remote WTRUs and/or child relay WTRUs have indicated that they are in RRC_CONNECTED and/or RRC_INACTIVE, the relay WTRU may forward and/or send the RLF indication to the attached remote and/or child relay WTRUs and/or may trigger re-establishment and/or cell and/or relay reselection procedure. In examples, if attached remote WTRUs and/or child relay WTRUs are in RRC_IDLE and/or RRC_INACTIVE, the relay WTRU may release the PC5-RRC connection, maintain the RRC connection until recovery by the relay or reception of recovery indication by a parent relay, and/or maintain the RRC connection until expiry of a time (e.g., via a timer without a recovery event), after which, the relay WTRU may release the PC5-RRC connection.

The action(s), the order of the actions, and/or the type and/or information provided in messaging (e.g., any messaging such as an RLF indication message, type of message, etc.) may depend on a hop number, weight (e.g., of or associated with a logical channel, such as a highest priority logical channel), and/or distance metric computed (e.g., computed into a value) by a relay WTRU, for example, the distance metric which may represent the number of hops or an overall weight (e.g., value) of the path to the destination node, where the overall weight (e.g., value) may be based on a combination of the number of hops and the weight/priority of the logical channel (e.g., highest priority logical channel). The destination node may be a network side node such as a gNB, base station, etc. . . . If the hop number or overall weight (e.g., the value computed based on the hop number and weight/priority of the logical channel weight) is above a threshold, the relay WTRU may send an indication to the remote WTRU(s) and/or the child relay WTRUs of an RLF without initiating a recovery procedure or reselection procedure. If the hop number and/or overall weight (e.g., the value computed based on the hop number and weight/priority of the logical channel) is below a threshold, the relay WTRU may trigger a recovery procedure or a reselection procedure (e.g., possibly in addition to sending the indication). In examples, the relay WTRU may send a first RLF indication type if the hop number and/or overall weight (e.g., the value computed based on the hop number and weight/priority of the logical channel) is below a threshold and may send a second RLF indication type and/or weight otherwise. The WTRU may compute an overall weight based on one or more of the following: a hop number, an operating condition (e.g., an RRC operating condition such as RRC_CONNECTED or RRC_IDLE); a QoS (e.g., weight/priority of a logical channel, such as a highest priority logical channel), and/or other factors described herein. For example, the WTRU may combine hop number and QoS (e.g., weight/priority of the logical channel, for example a highest priority logical channel, which may be a (e.g., highest priority) radio link control (RLC) channel) to determine an overall weighted value (e.g., a value mathematically associated with the logical channel weight and the number of hops) of distance to the network (e.g., gNB, base station, etc.), e.g., by multiplying the hop number by a factor selected based on the priority of the logical channel, where the logical channel may be associated with one or more remote WTRUs. The WTRU may combine hop number and operating condition (e.g., RRC operating condition). For example, the WTRU may combine hop number and RRC operating condition by multiplying the hop number by a first factor for an RRC_CONNECTED WTRU, a second factor for an RRC_INACTIVE WTRU, and a third factor for an RRC_IDLE WTRU.

The action(s), the order of the actions, and/or the type and/or information provided in messaging (e.g., any messaging such as an RLF indication message, type of message, etc.) may depend on preference and/or request information provided by the remote WTRU (e.g., as described herein). For example, the preference information may represent the ability of a remote WTRU to perform cell and/or relay selection at a given time. The preference information may represent the coverage situation (e.g., in-coverage (IC) or out-of-coverage (OOC)) of a remote WTRU. The preference information may represent the availability of an alternate relay WTRU and/or the presence of a direct Uu connection. Depending on content of the preference information, the relay WTRU may determine whether to send RLF indication immediately or to send an indication only after failed re-establishment by itself or a parent. Depending on content of the preference information, the relay WTRU may determine whether to send an indication for successful or failed re-establishment following informing the child WTRU of the RLF indication. In examples, if the expectation is that the child WTRU may perform re-establishment immediately after RLF indication, the relay WTRU may not send an indication of failed or successful re-establishment to the child WTRU after the RLF indication. A relay WTRU may trigger re-establishment if it receives, from at least one remote and/or child relay WTRU, an indication that the remote WTRU and/or child relay requests and/or prefers that the relay WTRU performs its own re-establishment procedure.

The action(s), the order of the actions, and/or the type and/or information provided in messaging (e.g., any messaging such as an RLF indication message, type of message, etc.) may depend on indication from one or more remote WTRUs and/or children relay WTRUs of successful recovery (e.g., re-establishment, reselection, access, etc.). For example, a relay WTRU may cancel an access procedure based on reception of an indication, from a remote WTRU and/or child relay WTRU, of successful re-establishment by that remote WTRU.

The action(s), the order of the actions, and/or the type and/or information provided in messaging (e.g., any messaging such as an RLF indication message, type of message, etc.) may depend on the interface of the hop (e.g., Uu or SL) and/or the hop number of the link where RLF was detected. A relay WTRU may indicate, via an RLF indication to a remote WTRU and/or child relay WTRU, whether an RLF is a Uu RLF or a SL RLF. A relay WTRU may indicate, via an RLF indication to a remote WTRU and/or child relay WTRU, the hop number and/or overall weight to the network (e.g., gNB, base station, etc.) of the link where the RLF occurred. A relay WTRU may include the identification of the hop and/or link (e.g., hop number) with the RLF indication.

The action(s), the order of the actions, and/or the type and/or information provided in messaging (e.g., any messaging such as an RLF indication message, type of message, etc.) may depend on a configured time (e.g., configured timer). For example, a relay WTRU, based on reception of an RLF indication, may start a time (e.g., timer). The relay WTRU may perform its own recovery procedure (e.g., re-establishment) and/or may trigger a cell and/or relay reselection procedure. Based on expiry of the time (e.g., a timer without recovery or reception of recovery), the relay WTRU may send a message to the remote WTRU and/or child relay WTRU. The value of the configured time (e.g., configured timer) and/or whether to configure the time (e.g., the timer compared to initiating the procedure immediately) may depend on the measured constant bit rate (CBR) at the relay WTRU, the QoS of expected data being relayed by the relay WTRU (e.g., based on the configuration of the RLC channels configured with the child or parent relay WTRU, the state of the child relay WTRU, remote WTRU, or the relay WTRU, and/or the hop number and/or overall weight of the path to the network (e.g., gNB, base station, etc.) associated with the relay WTRU).

The action(s), the order of the actions, and/or the type and/or information provided in messaging (e.g., any messaging such as an RLF indication message, type of message, etc.) may depend on the architecture of the relay (e.g., L2 relay verse L3 relay). For example, based on reception of an RLF indication from a parent relay WTRU and/or detection of SL RLF with a parent relay WTRU, an L2 relay may forward and/or send the RLF indication to a child relay WTRU, while an L3 relay WTRU may release the PC5-RRC connection and/or send an indication to upper layers (e.g., without transmission of the RLF indication).

The action(s), the order of the actions, and/or the type and/or information provided in messaging (e.g., any messaging such as an RLF indication message, type of message, etc.) may depend on the coverage situation of the relay WTRU. The coverage situation may include whether the relay WTRU is in-coverage or OOC, possibly of the same cell, RNA, public land mobile network (PLMN), or similar grouping of cells which is serving the relay WTRU (e.g., relayed via a parent relay WTRU) or a remote WTRU (e.g., based on indication received by the remote WTRU). In examples, the coverage situation may include whether the relay WTRU may find and/or select a parent relay WTRU and/or cell where it is served by the same cell, RNA, PLMN, or similar grouping of cells which is serving the relay WTRU (e.g., via a parent relay WTRU) or a remote WTRU (e.g., based on indication of such received by the remote WTRU). For example, a relay WTRU may, based on detection of SL-RLF and/or Uu RLF or based on reception of an RLF indication from a parent node, determine whether to send an indication message to a remote WTRU and/or child relay or the type of indication to send, depending on whether the relay WTRU may find (e.g., (re) select to) the same cell that it is currently being served by via the parent relay WTRU.

In examples, a relay WTRU may inform (e.g., send an indication to) a remote WTRU that has requested to receive an RLF indication, for example, the indication may be associated with (e.g., may be an indication of) an occurrence of an RLF (e.g., at the relay WTRU) and/or of a reception (e.g., by the relay WTRU) of an RLF indication from a parent WTRU. The relay WTRU may include in the indication information associated with (e.g., or dependent on) an operating condition such as the RRC operating condition of the relay WTRU. The operating condition may be an RRC_IDLE or RRC_INACTIVE condition. The operating condition may be an RRC_CONNECTED condition. The relay WTRU may perform a different recovery action depending on the operating condition. For example, a relay WTRU may send the indication of RLF to a remote WTRU (e.g., that has requested reception of the indication) based on the RLF determination and/or RLF indication from a parent relay WTRU. The relay WTRU may determine to send/send an RLF indication of a first type, for example, based at least on if the relay WTRU is in a first operating condition (e.g., RRC_CONNECTED). As disclosed herein, the determine to send/sending of the first type RLF indication may further depend on a value associated with a channel priority and/or number of hops. For example, if the relay WTRU is in the first operating condition and the value is below a threshold, the relay WTRU may send the first type RLF indication, or, if the value is above the threshold (e.g., equal to or above), the relay WTRU may send the second type RLF indication. In examples, the relay WTRU may send an RLF indication of a second type if the relay WTRU is in RRC_IDLE and/or RRC_INACTIVE or if the relay WTRU does not have an RRC state (e.g., does not have its own Uu traffic). The relay WTRU may (e.g., in addition to sending the indication) initiate a recovery procedure (e.g., re-establishment procedure for RRC_CONNECTED or reselection procedure for RRC_IDLE/RRC_INACTIVE). The relay WTRU may send a recovery indication in the case of successful or failed recovery (e.g., re-establishment) to the remote WTRU, for example, if the relay WTRU is in RRC_CONNECTED. In examples, the relay WTRU may not send the recovery indication to the remote WTRU if the relay WTRU is in RRC_IDLE or RRC_INACTIVE or if the relay WTRU does not have a configured RRC operating condition.

In examples, a relay WTRU may determine the type of RLF indication based at least on the QoS of the current relayed traffic (e.g., a priority of an associated channel). For example, the relay WTRU may determine the QoS of the current relayed traffic (e.g., priority of an associated channel) based on one or more parameters (e.g., specific parameters) of the (e.g., RLC) channel configuration (e.g., ingress or egress), such as priority. Based on the one or more parameters (e.g., the relay WTRU may be configured with a condition of the parameters mapping transmissions to a type of indication), the relay WTRU may determine whether to send a first type of indication or a second type of indication to the child WTRU.

In examples, a relay WTRU may determine the type of RLF indication to transmit to a child WTRU based at least on the type of indication received from a parent WTRU and/or other conditions determined at the relay WTRU. For example, a relay WTRU receiving a second type of indication (e.g., an indication to trigger a re-establishment and/or reselection, for example without a delay) may send (e.g., always send) a second type of indication to a child WTRU. A relay WTRU receiving a first RLF indication type may send a first RLF indication type to the child WTRU and/or may determine whether to send/send a first indication type based on the (e.g., RLC) channel configuration condition described herein associated with its children WTRU(s) (e.g., any of its children WTRU(s), where the determination may include other conditions as described herein.

A relay WTRU may determine the type of RLF indication to transmit to a child WTRU based on a combination of hop count and QoS (e.g., a priority of an associated channel). The relay WTRU may receive or determine) a hop count representing the number of hops that the relay WTRU is away from the network (e.g., gNB, base station, etc.). The relay WTRU may receive or determine a threshold, where the threshold may be a threshold number of hops for a given QoS level (e.g., where one or more of the following may apply: the QoS level may be a priority, such as a logical channel priority/weight; the number of hops for a given QoS level may be a value; or the QoS level may be determined by a parameter associated with the (e.g., RLC) channel configuration, for example of one or more connected children of the relay WTRU). The WTRU may send a second RLF type, for example, if the number of hops for a given QoS level is above the threshold. The WTRU may send a first RLF type if the number of hops for a given QoS level is not above the threshold.

A WTRU may send and/or forward a request to be informed of SL RLF and/or recovery. Information from the remote WTRUs (e.g., as described herein) which may affect the behavior based on RLF may be processed by a remote WTRU prior to transmitting to the relay WTRU. In examples, a WTRU (e.g., a remote WTRU or a relay WTRU) may send and/or forward a request to be informed of SL RLF by a parent relay WTRU. For example, a WTRU (e.g., remote WTRU or a relay WTRU) may send a request to be informed of a SL RLF by a parent relay WTRU based on one or more conditions described herein. A WTRU (e.g., a relay WTRU) may forward the request to a parent relay WTRU (e.g., based on reception from a remote WTRU) and/or combine the request with its own request based on its own conditions. The request may include an “or” operation of satisfying the conditions (e.g., any of the conditions) described herein between the child remote WTRUs (e.g., any of the child remote WTRUs) and the relay WTRU. If the relay WTRU receives a positive request and/or indication from one or more of its remote WTRUs or the relay WTRU satisfies the conditions, the relay WTRU may send a positive request and/or indication to a parent relay WTRU. A WTRU (e.g., a relay WTRU or a remote WTRU) may initiate a request (e.g., new request) and/or indication based on a change of its conditions. The request and/or indication may be sent if a condition goes from not satisfied to satisfied (e.g., in which it serves as a request) or from satisfied to not satisfied (e.g., in which it serves as a cancellation). A relay WTRU may maintain the request state of one or more of its remote WTRUs and send an indication based on RLF, successful recovery, or failed recovery to remote WTRUs (e.g., all remote WTRUs) which are in positive request states.

In examples, the WTRU (e.g., relay or remote WTRU) may request an RLF indication type (e.g., a specific RLF indication type) from a parent relay WTRU. An RLF indication type may include a reception of an RLF indication at different times (e.g., RLF detection, RLF recovery, failed RLF recovery, etc.) or may include the triggering of an indication at different times during RLF detection (e.g., based on a number of consecutive IS and/or OOS indications from Uu, and/or consecutive HARQ failures on SL) and/or an RLF indication informing whether the parent may re-establish and/or reselect the same or different cell (e.g., group) as currently attached (e.g., via a different path).

A WTRU (e.g., a relay WTRU or remote WTRU) may satisfy the conditions for sending a request (e.g., receiving or not receiving the RLF indication) based on one or more of the following: the RRC state of the WTRU, the QoS of the data (e.g., a priority/weight of a channel, for example a logical channel, such as an RLC channel) at the WTRU and/or a property of one or more Uu bearers at the WTRU, the presence of an alternate path to the network, or the hop number and/or overall weight to the network (e.g., gNB, base station, etc.).

A WTRU (e.g., a relay WTRU or remote WTRU) may satisfy the conditions for sending a request (e.g., receiving or not receiving the RLF indication) based on the RRC state of the WTRU. For example, the condition may be tied to one or more RRC states (e.g., the WTRU in RRC_CONNECTED). The WTRU may send the request if the WTRU transitions into RRC_CONNECTED and/or RRC_INACTIVE and the WTRU may send the cancellation if it transitions into RRC_IDLE and/or RRC_INACTIVE.

A WTRU (e.g., a relay WTRU or remote WTRU) may satisfy the conditions for sending a request (e.g., receiving or not receiving the RLF indication) based on the QoS of the data at the WTRU and/or a property of one or more Uu bearers at the WTRU. For example, the WTRU may be configured with a set of logical channel (LCH) priorities which may trigger the request if a LCH with that priority is configured and/or has data available for transmission.

A WTRU (e.g., a relay WTRU or remote WTRU) may satisfy the conditions for sending a request (e.g., receiving or not receiving the RLF indication) based on the presence of an alternate path to the network. For example, the WTRU may send a request if the WTRU does not have the Uu path (e.g., or a different relayed path) to the network configured. For example, the WTRU may send the request if the WTRU is not configured with dual and/or multiconnectivity.

A WTRU (e.g., a relay WTRU or remote WTRU) may satisfy the conditions for sending a request (e.g., receiving or not receiving the RLF indication) based on the hop number and/or overall weight to the gNB. For example, the WTRU may send the request if the WTRU's configured hop number and/or overall weight is above or below a threshold. For example, the WTRU may send the request if the WTRU has another path available with a hop number or overall weight above or below a threshold.

A WTRU may receive an indication of a set of remote WTRUs to which to forward the RLF indication and/or recover from the network. A relay WTRU may receive from the network (e.g., via an RRC message, paging message, and/or the like) the set of remote WTRUs (e.g., a set of WTRU IDs, path IDs, and/or the like) to which RLF indication and/or recovery may be sent. A relay WTRU may be configured with the RLF indication message types to be sent to a given relay WTRU.

A WTRU may determine its actions if receiving an RLF indication from a parent relay WTRU. In examples, the WTRU (e.g., remote WTRU or relay WTRU) may determine a set of actions to be performed based on reception of an RLF indication. A remote WTRU may determine whether and/or when (e.g., immediately, some time later, or based on reception of a subsequent indication) to trigger a re-establishment procedure, based on reception of RLF indication, based on one or more of the following: RRC state of the remote WTRU, whether the remote WTRU is serving as a relay WTRU to other remote WTRUs, the QoS of the data transmitted or received by the remote WTRU, the measured CBR, or the type and/or information received in the RLF indication. The QoS of the data transmitted or received by the remote WTRU may be represented by a parameter of one or more LCH(s) (e.g., LCH priority). For example, the remote WTRU may trigger re-establishment if one or more logical channels with a priority above a threshold are configured. The remote WTRU may trigger re-establishment if the WTRU is configured with at least one LCH which indicates it may trigger re-establishment. The QoS of the data transmitted or received by the remote WTRU may include determining a time (e.g., a timer) for waiting for a subsequent indication based on QoS. The measured CBR may be a condition of whether to trigger re-establishment or wait for subsequent indication based on whether the measured CBR is above or below a threshold. The measure CBR may include determining a time (e.g., a timer) for waiting for a subsequent indication based on CBR. The type and/or information received in the RLF indication may include the RRC state of its relay WTRU and/or a parent relay WTRU (e.g., any parent relay WTRU) configured along its path to the network. The information may include the QoS requirements of its relay WTRU and/or a parent relay WTRU (e.g., any parent relay WTRU) configured along its path to the network. The information may include the type of RLF indication received from the parent WTRU (e.g., type 1 or type 2).

A remote WTRU (e.g., in RRC_CONNECTED) may determine whether to trigger a re-establishment procedure or to delay triggering a re-establishment procedure based on (e.g., at) reception of an RLF indication, for example based on a type of RLF indication received. If the remote WTRU receives from the relay WTRU a first type RLF indication (e.g., representing an RRC_CONNECTED relay WTRU), the remote WTRU may delay initiation of the re-establishment until reception of a recovery or recovery failure procedure by the relay WTRU (e.g., the remote WTRU may wait for a time to determine if an affected relay WTRU is able to reestablish a connection). If the remote WTRU receives a second type RLF indication (e.g., representing an RRC_IDLE and/or RRC_INACTIVE relay WTRU or a relay WTRU with no RRC state), the remote WTRU may trigger (e.g., immediately trigger) a re-establishment procedure at reception of the RLF indication (e.g., without a delay time). The remote WTRU, based on reception of the first indication type, may start a time (e.g., via a timer). If the time (e.g., timer) expires prior to reception of a recovery indication or if a recovery failure indication is received prior to time (e.g., timer) expiry, the remote WTRU may trigger re-establishment. The remote WTRU may determine the value of the time (e.g., timer) based on one or more of operating condition (e.g., RRC operating condition) of the relay WTRU, QoS of the data at the remote WTRU, hop count (e.g., number of hops) or overall weight associated with the path from the remote WTRU to the network (e.g., where the overall weight (e.g., value) may be based on a combination of the number of hops and the weight/priority of the logical channel (e.g., highest priority logical channel).

A remote WTRU may determine a time (e.g., timer) for triggering re-establishment following RLF indication based on the QoS of the data the remote WTRU is transmitting (e.g., or one or more of its remote WTRUs is transmitting). A mechanism (e.g., any mechanism) for determining the QoS described herein (e.g., tied to an RLC channel configuration parameter based on configured QoS flows at the WTRU itself) may be considered to determine the QoS of the data the remote WTRU is transmitting. The WTRU may be configured with a first time (e.g., timer) associated with a first QoS level, configured with a second time (e.g., timer) associated with a second QoS level, and so on. Based on reception of an RLF indication (e.g., or determination of RLF), the WTRU may start the time (e.g., via a timer). The WTRU may trigger its re-selection and/or re-establishment procedure, for example, if the time (e.g., timer) expires without indication from a parent (e.g., reception of a recovery indication). The WTRU may wait a configured amount of time before starting its re-establishment procedure, where such amount of time may be QoS dependent.

In examples, a remote WTRU may determine a time (e.g., timer) for triggering re-establishment based on the RLF indication type received from the relay WTRU. For example, the remote WTRU may wait a first time to trigger re-establishment if receiving a first RLF indication type and may wait a second amount of time before triggering re-establishment if receiving a second RLF indication type.

Combinations of techniques described herein (e.g., determination of an amount of time to wait before the WTRU initiates its own re-establishment based on a combination of QoS, number of hops, RLF indication type, etc.) may be used.

Successful (re) selection of a cell and/or relay and re-establishment may be informed to a remote WTRU. Whether to perform cell and/or relay (re) selection may be conditioned on one or more aspects at the relay and/or its child WTRUs. A relay WTRU may trigger a cell (re) selection and/or a relay (re) selection procedure based on detection of RLF or reception of RLF indication from a parent WTRU. Whether the relay triggers the procedure may depend on conditions and/or aspects described herein (e.g., conditions for sending an RLF indication). For example, whether the relay triggers the procedure may depend on one or more of the following conditions: the relay WTRU may trigger a cell and/or relay (re) selection if it is in RRC_CONNECTED and/or RRC_INACTIVE, one or more of the remote WTRUs are in RRC_CONNECTED and/or RRC_INACTIVE, or the relay WTRU has received an active request from a remote WTRU.

Whether to select a relay may be conditioned on if the relay is in RRC_CONNECTED. A relay WTRU which performs cell and/or relay (re) selection may restrict selection of a relay to a relay which is in RRC_CONNECTED. A relay WTRU may enable the restriction based on condition(s) described herein. For example, the conditions may include that at least one of the remote WTRUs is in RRC_CONNECTED, depend on the QoS and/or bearer configuration with the remote WTRUs, and/or based on request from the relay WTRU.

The techniques described herein may be applied to one or more of the dual connectivity (DC) architectures (e.g., described herein) for multiconnectivity.

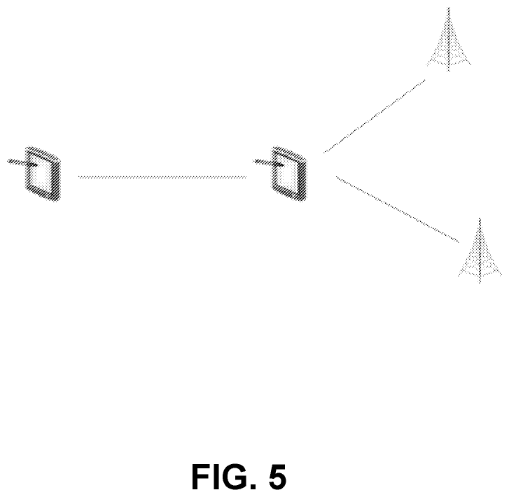

FIG. 5 shows an example architecture where the relay WTRU (e.g., where a relay WTRU may be WTRU used as an example) is configured in DC with a master cell group (MCG) and a secondary cell group (SCG). For example, the relay WTRU may be configured in DC and the remote WTRU(s) may be unaware of the configuration. In examples, the remote WTRU may be unaware of the DC configuration and may be configured with a single PDCP entity. The relay WTRU may be configured to relay the remote WTRUs traffic via the MCG and/or SCG (e.g., via a configuration which maps an ingress RLC channel to an egress RLC channel on MCG and/or SCG). In examples, the remote WTRU may be configured with two different PDCP entities and may determine which to use based on information provided by the relay WTRU. The remote WTRU may use a first PDCP entity (e.g., only a first PDCP entity) until an RLF or related event is triggered at the relay WTRU and may start using the second PDCP entity following.

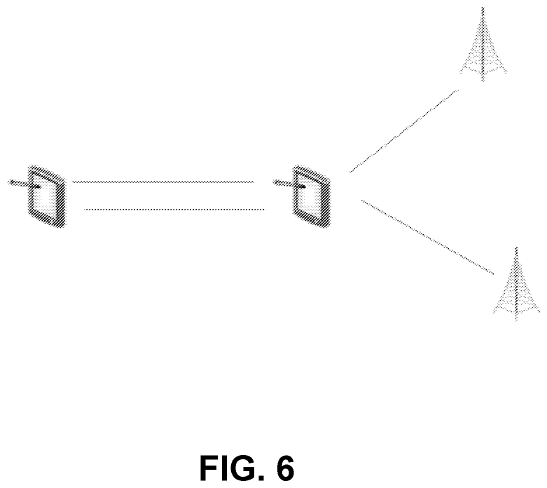

FIG. 6 shows an example architecture where the relay WTRU is configured with an MCG and a SCG. For example, the DC configuration may be at the remote WTRU, where the two legs (e.g., each of the two legs) may go through the relay. The remote WTRU may be configured with two different PDCP entities and/or sets of bearers that may be used simultaneously. The relay WTRU may map the ingress RLC channels associated with the first PDCP entity and the ingress RLC channels associated with the second PDCP entity to MCG and/or SCG (e.g., based on configuration).

Relay WTRU indication of RLF to a remote WTRU may depend on the type of RLF (e.g., M-RLF or S-RLF). In examples, a relay WTRU may send an indication to the remote WTRU of the RLF type based on detection of an RLF (e.g., M-RLF verse S-RLF or Uu RLF verse SL RLF). The relay WTRU may send an indication to the remote WTRU of the RLF type through transmission of a different RLF type (e.g., using a different message or IE) and/or by providing different information in the RLF message to the remote WTRU. For example, based on M-RLF, the relay WTRU may send an indication to the remote WTRU that the RLF is an M-RLF. Based on detection of S-RLF, the relay WTRU may send an indication to the remote WTRU that the RLF is an S-RLF.

In examples, whether and/or when a relay WTRU informs a remote WTRU of RLF may depend on the type of RLF (e.g., M-RLF or S-RLF) triggered at the relay WTRU. For example, the relay WTRU may inform the remote WTRU of an RLF if (e.g., only if) the RLF is an M-RLF and may not send an indication to the remote WTRU of an S-RLF, or vice versa.

Whether and/or when a relay WTRU informs a remote WTRU of RLF may depend on the type of RLF (e.g., M-RLF or S-RLF) triggered at the relay WTRU, in addition to the bearer mapping and/or adaptation layer configuration (e.g., associated with SRB for the remote WTRU) at the relay WTRU. This may depend on whether the SL RLC channel carrying remote WTRU SRB is mapped to an MCG or SCG Uu RLC channel at the relay WTRU. For example, the relay WTRU may indicate RLF to the remote WTRU if the RLF (e.g., M-RLF or S-RLF) corresponds to the cell group over which the SL RLC channel carrying remote WTRU SRB is mapped (e.g., based on adaptation layer configuration). The relay WTRU may not indicate RLF, for example, if the RLF occurs over the cell group where the SL RLC channel carrying remote WTRU SRB is not mapped (e.g., based on adaptation layer configuration).

Whether and/or when a relay WTRU informs a remote WTRU of RLF and/or the type of RLF indicated to the remote WTRU may depend on the SRB configuration at the relay WTRU and/or whether the relay WTRU is configured to perform MCG failure procedure. For example, based on MCG RLF, if the relay WTRU is configured to perform MCG failure procedure and/or if the relay WTRU is configured with split SRB1 or SRB3, the relay WTRU may send a first indication and/or indication type, and if the WTRU is not configured to perform MCG failure procedure, the relay WTRU may send a second indication type.

Relay WTRU and/or remote WTRU may suspend SL transmission and/or reception based on RLF indication transmission and/or reception. In examples, the relay WTRU and/or the remote WTRU may suspend one of (e.g., or both of) SL transmission and/or reception based on RLF determination (e.g., by the relay WTRU), transmission of the SL RLF indication message (e.g., by the relay WTRU), and/or reception of an RLF indication message (e.g., by a relay WTRU or remote WTRU). For example, a relay WTRU may suspend SL reception and/or forwarding of relayed data in the UL direction based on M-RLF and may continue to perform SL transmission and/or forwarding of relayed data in the DL direction. For example, a remote WTRU may suspend SL transmission based on reception of an RLF indication from the relay and may continue to perform SL reception.

The relay WTRU may, based on MCG failure, do one or more of the following if it is configured to perform MCG failure procedure. The relay WTRU may send a first RLF type to the remote WTRU. The remote WTRU may suspend relayed SL transmissions and/or receptions (e.g., all relayed SL transmissions and/or receptions) based on reception of the indication. The relay WTRU may suspend SL transmission and may continue SL reception (e.g., continue SL reception only). The relay WTRU may suspend relaying (e.g. all relaying) associated with its remote WTRUs (e.g., SL transmission and/or reception). The relay WTRU may suspend SL reception and may continue SL transmission (e.g., continue SL transmission only). The relay WTRU may initiate MCG failure procedure with the network and may wait for a response. If the MCG failure procedure time (e.g., procedure timer) expires, the MCG may send a second RLF type and/or indication to the remote WTRU. The relay WTRU may release the PC5 RRC connection based on transmission of the second indication. If the MCG failure procedure is successful and the relay WTRU receives a reconfiguration from the network, the relay WTRU may perform one or more of the following. The relay WTRU may send an indication to the remote WTRU and the remote WTRU and/or the relay WTRU may resume suspended relayed SL transmissions and/or receptions (e.g., any suspended relayed SL transmissions and/or receptions) based on reception or transmission of the indication. If the relay WTRU receives an embedded reconfiguration message for the remote WTRU, the relay WTRU may forward the message to the relay WTRU on SL. The remote WTRU and/or the relay WTRU may resume suspended relayed SL transmissions and/or receptions (e.g., any suspended relayed SL transmission and/or receptions) based on reception or transmission of the message. The relay WTRU may not transmit a message (e.g., any message) and/or indication (e.g., any indication) to the relay WTRU. The relay WTRU may resume suspended transmission and/or reception (e.g., any suspended relayed SL transmission and/or reception) based on reception of the network reconfiguration or some time (e.g., defined by a time) following reception of the network reconfiguration.

The relay WTRU may, based on SCG failure, do one or more of the following if it is configured to perform MCG failure procedure. The relay WTRU may send a third RLF type to the remote WTRU. In examples, the relay WTRU may not send an RLF indication (e.g., any RLF indication) to the remote WTRU if it is configured to do so based on other factors described herein.

The relay WTRU may, based on MCG failure, do one or more of the following if it is not configured to perform MCG failure procedure. The relay WTRU may send a fourth RLF type.

The relay WTRU may, based on SCG failure, do one or more of the following if it not configured to perform MCG failure procedure. The relay WTRU may send a third RLF type to the remote WTRU. In examples, the relay WTRU may not send an RLF indication (e.g., any RLF indication) to the remote WTRU if it is configured to do so based on other factors described herein.

Remote WTRU may have different behavior based on reception of different RLF types from a relay WTRU. A remote WTRU may perform a different action, or set of actions, depending on the type of RLF the remote WTRU receives. The RLF type may be associated directly with M-RLF or S-RLF at the relay WTRU. In examples, the RLF type may be associated with events (e.g., any event) at the relay WTRU described herein.

One or more of the following events and/or behaviors may be associated with one event or with multiple events: initiate re-establishment immediately; initiate re-establishment after a specific time (e.g., specific timer) is expired (e.g., re-setting the timer following reception of another RLF type indication or NW message); set a time (e.g., re-establishment timer or timer until re-establishment is triggered following RLF indication) based on the type of indication; or modify the transmission parameters on sidelink. Modifying the transmission parameters on sidelink may include one or more of the following: increase and/or reduce the maximum SL channel size and/or number of channels; enable or disable SL HARQ and/or SL RLF monitoring; change the transmission mode (e.g., change from mode 1 to mode 2 or vice versa); or change the sensing behavior (e.g., change from sensing based to random selection or vice versa).

One or more of the following events and/or behaviors may be associated with one event or with multiple events: suspend SL transmissions for bearers (e.g., all bearers) without immediately initiating re-establishment; suspend SL transmissions (e.g., for a subset of bearers) immediately without initiating re-establishment; or determine that a procedure (e.g., re-establishment, reselection, or any other RRC procedure) may be triggered by one RLF type rather than another RLF type. For example, reception of a first RLF may ensure that the WTRU triggers re-establishment if a second type is received, while reception of a third RLF type may ensure that the WTRU triggers re-establishment if a fourth RLF type is received.

One or more of the following events and/or behaviors may be associated with one event or with multiple events: activate, deactivate, or switch a PDCP entity (e.g., described herein); or suspend one set of bearers compared to a different set of bearers.

Remote WTRU may determine which Uu bearers to suspend transmission on based on the RLF indication. In examples, a remote WTRU may receive an RLF type and/or information via an RLF indication (e.g., M-RLF vs S-RLF) and may determine the set of bearers to suspend based on the information in the RLF indication. For example, a WTRU may be configured with a set of bearers associated with a first RLF type and/or indication and a second set of bearers associated with a second RLF type and/or indication. The remote WTRU may suspend the transmission for the set of bearers associated with the indication (e.g., specific indication) if the indication is received. A remote WTRU may suspend transmission of bearers (e.g., all transmission of bearers) or may suspend transmission of bearers associated with relaying via a specific relay, if it receives a type and/or indication (e.g., specific type and/or indication).

Remote WTRU may activate, deactivate, or switch a PDCP entity based on reception of an RLF indication. In examples, a remote WTRU may be configured with two different PDCP entities (e.g., a first and/or primary PDCP entity and a second and/or secondary PDCP entity). The remote WTRU may transmit data to the primary PDCP entity under normal conditions. Based on reception of an indication (e.g., RLF indication) from the remote WTRU, the remote WTRU may change to transmission of data via the second PDCP entity. The remote WTRU may continue to use the second PDCP entity until one or more of the following: indication from the relay WTRU (e.g., recovery indication or failure indication); for a period of time (e.g., expiry of a timer started at reception of the first indication); or until reception of an indication from the relay WTRU and/or configuration from the network.

Following one or more of the events described herein, the remote WTRU may perform one or more of the following: trigger re-selection and/or re-establishment or switch to using the first and/or primary PDCP entity. The behavior (e.g., specific behavior as described herein) may depend on the nature and/or type of the event.

The remote WTRU may switch from a primary to secondary PDCP entity based on reception of an RLF indication from the relay WTRU. The remote WTRU may start a recovery time (e.g., via a recovery timer). Based on reception of a recovery failure indication and/or or expiry of the time (e.g., timer), the remote WTRU may trigger re-establishment procedure. On the other hand, based on reception of a recovery indication from the relay WTRU, the remote WTRU may switch to using the primary PDCP entity.

Whether and/or when switching of a PDCP entity is allowed may depend on the RLF type and/or indication (e.g., M-RLF vs S-RLF) from the relay WTRU and/or the current PDCP entity being used by the remote WTRU. For example, a remote WTRU may switch from a primary PDCP entity to a secondary PDCP entity if M-RLF is indicated by the relay WTRU and may not perform the switch if S-RLF is indicated. For example, the remote WTRU may switch from a first to a second entity for one type of RLF and not for another type of RLF. A remote WTRU may be using a secondary PDCP entity. If S-RLF is received from the relay WTRU, the remote WTRU may switch to the primary PDCP entity. In examples, the remote WTRU may be using a primary PDCP entity. If M-RLF is received from the relay WTRU, the remote WTRU may suspend bearer transmissions and/or receptions (e.g., all bearers transmission and/or receptions) and may not switch the PDCP entity.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A first wireless transmit/receive unit (WTRU) associated with a second WTRU, the first WTRU comprising:
a processor configured to:
receive an indication of a threshold;
determine a number of hops from the first WTRU to a network; and
send a radio link failure (RLF) indication to the second WTRU, wherein a type of the RLF indication is determined based on the threshold and a value, wherein the value is based on one or more of a logical channel weight or the number of hops from the first WTRU to the network, and wherein the type of the RLF indication is a first type RLF indication or a second type RLF indication.

20. The first WTRU of claim 19, wherein the type of the RLF indication is determined to be the first type RLF indication if the value is greater than the threshold.

21. The first WTRU of claim 19, wherein the first type RLF indication indicates to remain connected to a sidelink (SL) associated with the first WTRU.

22. The first WTRU of claim 19, wherein the type of the RLF indication is determined to be the second type RLF indication if the value is less than the threshold.

23. The first WTRU of claim 19, wherein the second type RLF indication indicates to perform a reselection.

24. The first WTRU of claim 19, wherein the second type RLF indication indicates to disconnect from a SL associated with the first WTRU, and wherein the second type RLF indication indicates to connect to an SL associated with a third WTRU.

25. The first WTRU of claim 19, wherein the type of the RLF indication is determined further based on the first WTRU being associated with a first operating condition and not having received the second type RLF indication from a parent relay WTRU.

26. The first WTRU of claim 19, wherein the processor is further configured to determine that an RLF has occurred.

27. The first WTRU of claim 19, wherein the first WTRU comprises a relay WTRU, and wherein the second WTRU comprises a remote WTRU.

28. The first WTRU of claim 19, wherein the value is based on the logical channel weight and the number of hops from the first WTRU to the network.

29. A method of a first wireless transmit/receive unit (WTRU) associated with a second WTRU, the method comprising:
receiving an indication of a threshold;
determining a number of hops from the first WTRU to a network; and
sending a radio link failure (RLF) indication to the second WTRU, wherein a type of the RLF indication is determined based on the threshold and a value, wherein the value is based on one or more of a logical channel weight or the number of hops from the first WTRU to the network, and wherein the type of the RLF indication is a first type RLF indication or a second type RLF indication.

30. The method of claim 29, wherein the type of the RLF indication is determined to be the second type RLF indication if the value is less than the threshold, and wherein the second type RLF indication indicates to perform a reselection.

31. The method of claim 29, wherein the second type RLF indication indicates to disconnect from a SL associated with the first WTRU, and wherein the second type RLF indication indicates to connect to an SL associated with a third WTRU.

32. The method of claim 29, wherein the method further comprises determining that an RLF has occurred.

33. The method of claim 29, wherein the first WTRU comprises a relay WTRU, and wherein the second WTRU comprises a remote WTRU.
